(19) United States
(12) Patent Application Publication
(10) Pub. No.: US 2002/0079850 A1
(43) Pub. Date: Jun. 27, 2002

(54) Apparatus for manual control, in particular of a driving gear and/or lifting gear of a load-lifting device

(75) Inventors: Philipp Hortig, Clinton Twp., MI (US); Giorgio Maccioni, Witten (DE); Anton Munzebrock, Dortmund (DE); Michael Rohr, Dortmund (DE)

Correspondence Address: HENRY M FEIEREISEN, 350 FIFTH AVENUE, SUITE 3220, NEW YORK, NY, 10118, US

(73) Assignee: Demag Cranes & Components GmbH, Wetter (DE)

(21) Appl. No.: 10/032,305

(22) Filed: Dec. 21, 2001

Related U.S. Application Data
(60) Provisional application No. 60/260,578, filed on Jan. 8, 2001.

(30) Foreign Application Priority Data
Dec. 27, 2000 (DE) 100 65 847.4

(51) Int. Cl. H02P 1/00

(52) U.S. Cl. 318/2

(57) ABSTRACT

Apparatus for the manual control in particular of a driving and/or lifting gear of a hoisting device, includes a control element in the form of a handle for inputting at least one desired value by subjecting the control element to a manual force, and at least one electrical transducer which is coupled to the control element for converting the manual force, acting in a desired direction, into an electric signal. In order to provide a compact manual-control apparatus which requires basically no displacement, the control element is prestressed in the desired direction, and the transducer includes a force sensor having a sensor surface arranged transversely to the desired direction for interaction with the control element.

### CROSS-REFERENCES TO RELATED APPLICATIONS

This application claims the benefit of prior filed provisional application, Appl. No. 60/260,578, filed Jan. 8, 2001, pursuant to 35 U.S.C. 119(e), the subject matter of which is incorporated herein by reference.

This application claims the priority of German Patent Application Serial No. DE 100 65 847.4, filed Dec. 27, 2000, the subject matter of which is incorporated herein by reference.

### BACKGROUND OF THE INVENTION

The present invention relates, in general, to an apparatus for manual control, in particular for operating a driving and/or lifting gear of a hoisting device.

Control apparatuses are known having a control element, configured as a handle which can be grasped by the hand of an operator, for inputting at least one desired value by actuating the control element through application of a manual force. Coupled to the control element is an electrical transducer for converting the manual force acting in an desired direction into an electric signal. German Pat. No. DE 297 19 865 U1 discloses the use of a handle for controlling a driving and/or lifting gear of a hoisting device, whereby a control system is instructed through movement of the handle to displace the hoist and to operate the hoist at the respective speed. The magnitude of the manual force determines hereby the magnitude of the control signal and thus the desired value for the control system. Conversion of the manual force acting in a desired direction, is implemented by a respective electrical transducer which is coupled to the handle.

This conventional manual control apparatus suffers shortcomings because of its great size and the need for a substantial displacement of the handle from the neutral position, so that operation of the manual control apparatus becomes difficult.

It would therefore be desirable and advantageous to provide an improved hand-held control apparatus for manually controlling a driving and/or lifting gear of a hoisting device, which obviates prior art shortcomings and requires basically no displacement paths.

### SUMMARY OF THE INVENTION

According to one aspect of the present invention, an apparatus for manual control of a driving and/or lifting gear of a hoisting device includes a control element configured as handle for inputting at least one desired value by applying a manual force upon the control element; a biasing unit for prestressing the control element in a desired direction; and at least one electrical transducer, coupled to the control element, for converting the manual force acting in a desired direction into an electric signal, wherein the transducer includes a force sensor having a sensor surface which extends perpendicular to the desired direction and interacts with the control element.

The present invention resolves prior art problems by prestressing the control element in each direction, and by providing the transducer with a sensor surface which is part of a force sensor and arranged perpendicular to the desired direction, for interaction with the control element. As a consequence of the prestressed configuration, the control element can be operated with no or only very little movement (pivoting, shift). It is also possible to use a highly sensitive small linear force sensor which senses the manual force acting in an desired direction and converts it into a corresponding control signal.

According to another feature of the present invention, the control element may interact with the sensor surface via a push rod formed with a curved end surface resting against the sensor surface to thereby realize a uniform transmission of the forces. Suitably, a ball is placed into the end surface and partially projects out.

According to another feature of the present invention, the sensor may include a bridge circuit of electrical resistors mounted on the sensor surface to thereby realize a high linearity with a high level of sensitivity. The sensor is particularly temperature-stable using a ceramic plate as carrier for the sensor surface.

In order to keep the force acting on the sensor surface to a minimum, the control element may be supported on the push rod via a first elastic member which loads the control element in the desired direction.

In order to simplify installation, the sensor surface, the push rod and the elastic member can be arranged in a common sensor housing having an inside surface for indirectly supporting the first elastic member.

The sensor can be operated in two opposite directions (direction and counter-direction), when the first elastic member is supported on the inside surface of the sensor housing via a second elastic member though interposition of an actuating element which is accessible from outside and operated in the desired direction by the control element. Depending on the operating direction, the sensor surface is arranged in parallel relationship or transverse relationship to the longitudinal axis of the control element.

A particularly small configuration can be realized by configuring the two elastic members as helical springs of different diameters, and the actuating element in the manner of a hat with outwardly projecting fin and a depression, whereby the helical spring with greater inner diameter is supported by the fin and by the inside housing surface, and the helical spring with smaller outer diameter is insertable in the depression and supported by the base of the depression and by the push rod.

According to another feature of the present invention, the control element is swingable about a pivot axis arranged transversely to its longitudinal axis and/or shiftable in the direction of the longitudinal axis so as to allow configuration of the transducer with components of greater manufacturing tolerance.

A basic support of the control element can be implemented by providing a metal tube which extends in coaxial relationship to the longitudinal axis and is guided through the control element. Attachment of the control element to a hoisting device, can be implemented by connecting the top end of the metal tube to a cable and the bottom end to a load-receiving member.

In order to realize a control in three independent directions, a transducer is provided in each of the three directions, whereby all three directions and the longitudinal axes of the transducers, parallel thereto, extend perpendicular to one another.

According to another feature of the present invention, a light barrier may be provided on the control element for delivering an actuating signal when the hand grasps the control element so as to sense the operating state of the control element. Ease of operation is enhanced, when, in the absence of an actuating signal, the transducer signal is nullified.

In order to easily initiate further control operations, switching elements, for example in the form of push buttons may be provided, which can be actuated from the control element.

According to another feature of the present invention, a flexible printed circuit board may be installed which complements the inner contour of the control element, so as to realize a compact control element.

### BRIEF DESCRIPTION OF THE DRAWING

Other features and advantages of the present invention will be more readily apparent upon reading the following description of a currently preferred exemplified embodiment of the invention with reference to the accompanying drawing, in which:

FIG. 1 is a schematic front and side perspective illustration of a hand-held control apparatus;

FIG. 2 is a sectional view through the control apparatus of FIG. 1;

FIG. 3 is an enlarged detailed view of the control apparatus, illustrating in particular an incorporated transducer;

FIG. 4 is a three-dimensional sectional view, on an enlarged scale, of the transducer of FIG. 3;

FIG. 5 is a schematic illustration of the transducer accommodated in a housing; and

FIG. 6 is a sectional view of a variation of a hand-held control apparatus shows the apparatus according to the present invention, with transducers arranged in directions perpendicular to one another.

### DETAILED DESCRIPTION OF PREFERRED EMBODIMENTS

Throughout all the Figures, same or corresponding elements are generally indicated by same reference numerals.

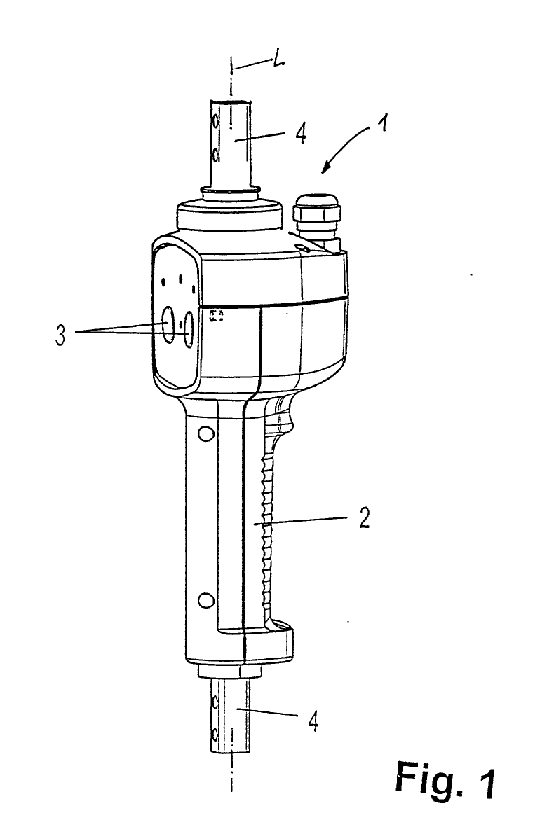

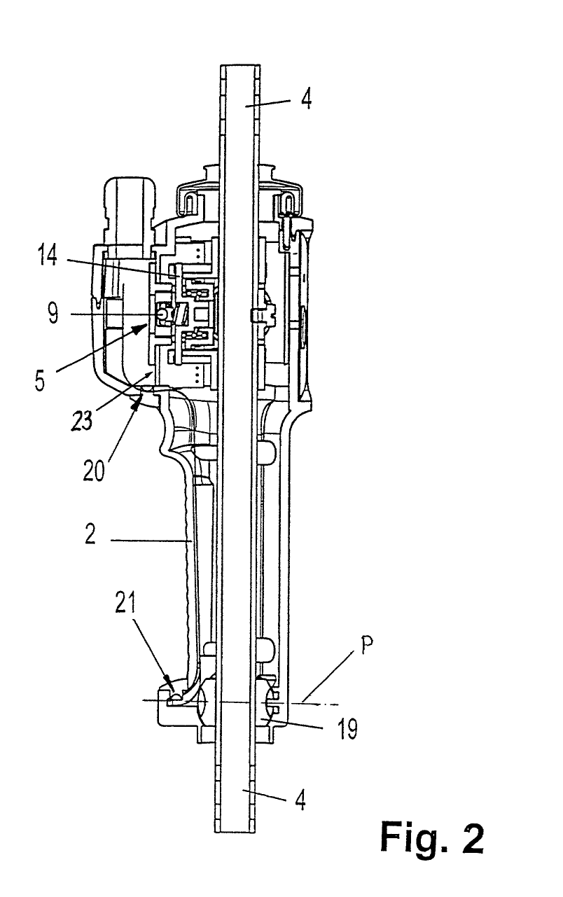

Turning now to the drawing, and in particular to FIG. 1, there is shown a schematic front and side perspective illustration of a hand-held control apparatus, generally designated by reference numeral 1 for manually controlling, e.g., a driving and lifting gear of a hoisting device (not shown). The control apparatus 1 includes a control element 2 which is configured as a handle and has an upper housing portion 18 which is provided with push buttons as switching elements 3 and suitably connected to the control element 2 by a linkage, generally designated by reference numeral 23 (FIG. 2). The switching elements 3 can easily be reached and actuated by the thumb of an operator, for example in order to trigger an emergency switch-off. A metal tube 4 is guided longitudinally through the control element 2 in coaxial relationship to the longitudinal axis L of the control element 2 and movably secured thereto. A cable, not shown, is attached to the upper end of the metal tube 4 and a load-receiving member, not shown, is attached to the lower end thereof. For operation and inputting a desired value, the control element 2 is embraced by the hand of the operator and acted upon by a force applied by the hand.

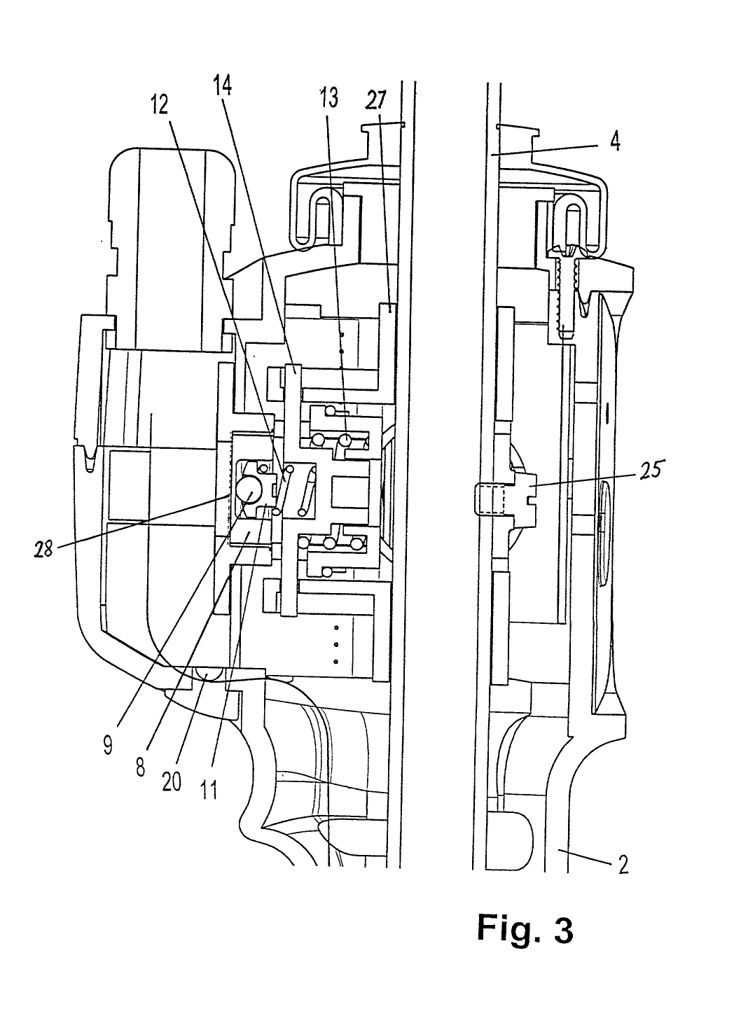

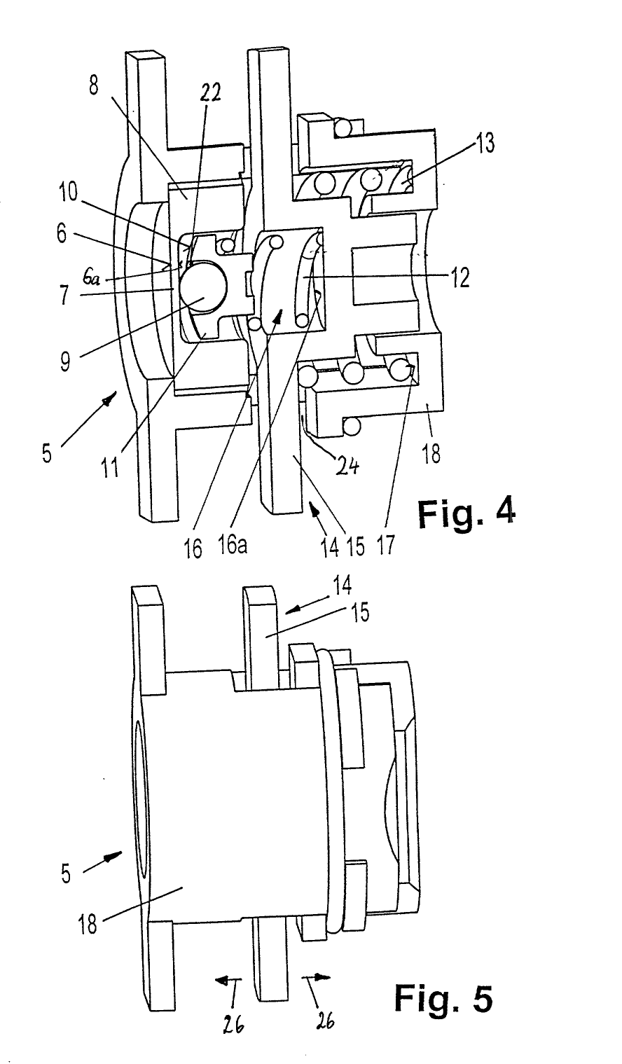

An electrical transducer, generally designated by reference numeral 5 in FIG. 2 and shown in more detail in FIGS. 3 and 4, is responsive to the force applied by the operator upon the control element 2 in a particular direction, here in X direction, as indicated by the double arrow in FIG. 2, in which the transducer 5 is effective, and converts the applied force into an electric signal. The electric signal is transmitted to a, not shown, motor for implementing a movement of a load in the X direction. It will be appreciated by persons skilled in the art that the control apparatus 1 must contain much mechanical apparatus which does not appear in the Figures, e.g. the motor or electric connection of the switching elements to the motor. However, these components, like much other necessary components, have been omitted from the Figures for the sake of simplicity.

As shown in FIG. 4, the transducer 5 is accommodated in the housing portion 18 and secured by screw fastener 25 to the metal tube 4 (FIG. 3). The transducer 5 includes a cylindrical ceramic substrate 8 having a U-shaped configuration with a ceramic plate 7 which has an outwardly facing sensor surface 6. Mounted on the sensor surface 6 is a, not shown, bridge circuit having electrical resistors and operatively connected to an electronics unit, not shown. Resting against the opposite inside surface 6a of the ceramic plate 7 is a ball 9 which is received in a calotte-shaped pocket 22 of a T-shaped push rod 11 and partially projects beyond a curved end surface 10 of the push rod 11 to abut against the confronting inside surface 6a of the ceramic plate 7. Disposed inwards of the ceramic substrate 8 is an actuating element, generally designated by reference numeral 14. The actuating element 14 has a generally hat-like configuration and is formed at its end proximal to the ceramic substrate 8 with a depression 16 and an outwardly projecting fin 15 which extends on opposite sides at sufficient clearance through respective slots 24 in the housing portion 18 (cf. FIG. 5). Interaction between the control element 2 and the sensor surface 6 of the ceramic plate 7 is realized via the actuating element 14, the push rod 11 and elastic members 12, 13. In a currently preferred embodiment, the elastic members 12, 13 are provided as helical springs. The helical springs 12, 13 have different diameters, with the helical spring 12 of smaller diameter being placed in the helical spring 13 of greater diameter, i.e. the helical spring 12 has an outer diameter which is smaller than an inner diameter of the helical spring 13. A base 16a bounds the depression 16 and supports one end of the helical spring 12 which is received in the depression 16. The other end of the helical spring 12 is supported by the push rod 11. The greater helical spring 13 has one end supported by the fin 15 and another end supported by an inner surface wall 17 of the housing portion 18.

The actuating element 14 is operatively connected to the control element 2 via a suitable linkage including an angle 27 by which the actuating element is mounted onto the metal tube 4 and secured by a screw fastener 25, so as to transmit the applied force upon the control element 2 via the actuating element 14, helical springs 12, 13, push rod 11 onto the sensor surface 6. The actuating element 14, shown in FIG. 5 in neutral position, can be displaced within the housing portion 18, as indicated by arrows 26, so as to act on the sensor surface 6 to thereby generate an electric response that is proportional to the magnitude and direction of the applied force upon the control element 2. The sensor surface 6 is so oriented as to extend perpendicular to the direction of displacement, here the X direction.

The helical spring 12 biases the control element 2 in the X direction, i.e. longitudinal of the helical spring 12. At the same time, the actuating element 14 is subjected to an opposite force applied by the helical spring 13. The spring constants of the two helical springs 12, 13 are selected such that the actuating element 14 in the neutral position is located approximately in mid-section in the slots 24 of the housing 18.

Conceivably, the two helical springs 12, 13 could be of very stiff design so that the actuating element 14 is immobile, when acted upon by the control element 2. However, in the case of greater fabrication tolerances of the helical springs 12, 13, some play should be provided to thereby allow mobility of the actuating element 14. Accordingly, as shown in FIG. 2, a pivot element 19 is arranged on the metal tube 4 so that the control element 2 is able to swing about the pivot element 19, with the pivot axis P extending transversely to the longitudinal axis L of the control element 2.

As is further shown in FIG. 2, the control apparatus 1 is provided with a light barrier comprised of a light emitter 20 and a light receiver 21, for delivering an actuating signal when the operator's hand embraces the control element 2.

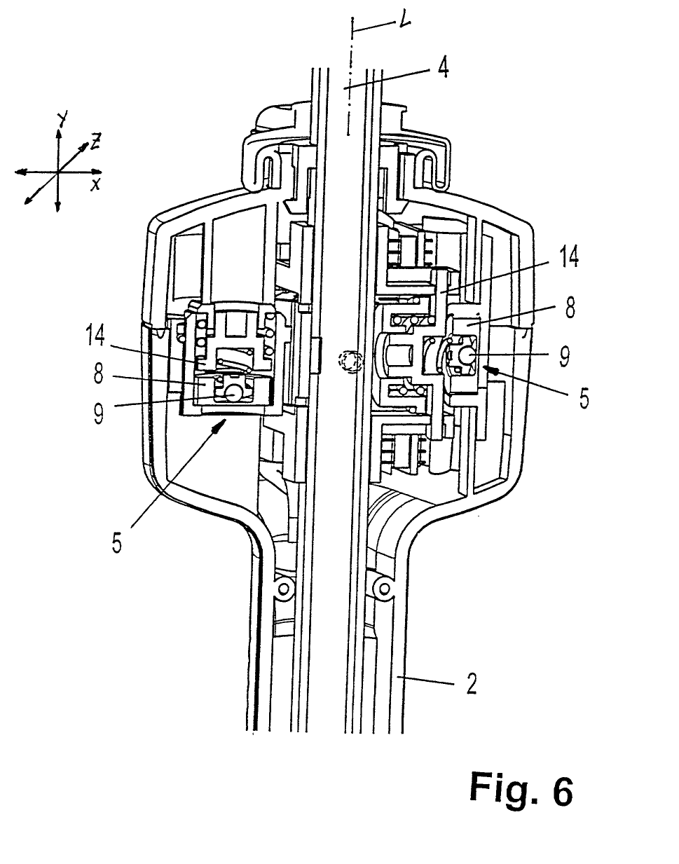

Referring now to FIG. 6, there is shown a sectional view of a variation of a hand-held control apparatus according to the present invention. Parts corresponding with those in FIGS. 1 to 5 are denoted by identical reference numerals and not explained again. In this embodiment, provision is made for the provision of three transducers 5 for response to forces applied upon the control element 2 in each of three orthogonal directions X, Y, Z. Thus, the manual force can be sensed in three directions, with the three transducers 5 arranged perpendicular to one another and allowing a three-dimensional control mechanism. A first one of the transducers 5 is shown on the right-hand side of FIG. 1 and is oriented transversely to the longitudinal axis L for responding to a force in the X-direction, with the sensor surface 6 of the first transducer 5 extending in parallel relationship to the longitudinal axis L. A second one of the transducers 5 is shown on the left-hand side of FIG. 1 and is oriented in the direction of the longitudinal axis L for responding to a force in the Y-direction, with the sensor surface 6 of the second transducer 5 extending transversely to the longitudinal axis L. A third one of the transducers 5 is not visible in the projection of FIG. 6 and located in the same plane as the right-hand transducer 5 in perpendicular relationship thereto for responding to a force in the Z-direction, i.e. into the drawing plane, with the sensor surface 6 of the third transducer 5 extending transversely to the longitudinal axis L. The X, Y and Z directions are shown symbolically by the diagram next to FIG. 6. Thus, in each case, the sensor surface 6 of each of the transducers 5 extends perpendicular to the direction of displacement.

The left-hand or second transducer 5 has lower and upper ends which are supported by the housing 18. The control element 2 is not only swingable about the pivot element 19 but the pivot element 19 is so configured as to allow also a shift of the control element 2 by approximately 1-2 mm along the metal tube 4.

In the absence of an actuating signal, a null balance occurs of the electric transducer signal. Consequently, the transducer signal is nullified irrespective of the precise central position in which the non-actuated actuating element 14 is located.

A simple and yet compact configuration of the control element 2 can be ensured by arranging in the upper housing portion 18 of the control element 2 a flexible printed circuit board 28 which is shown in FIG. 3 by broken line and denoted by reference numeral 28. This allows cost-effective installation and configuration of the printed circuit board to complement an inner contour of the control element 2.

While the invention has been illustrated and described as embodied in an apparatus for manual control, in particular of a driving gear and/or lifting gear of a load-lifting device, it is not intended to be limited to the details shown since various modifications and structural changes may be made without departing in any way from the spirit of the present invention.

What is claimed as new and desired to be protected by Letters Patent is set forth in the appended claims:

What is claimed is:

1. Apparatus for manual control of a driving and/or lifting gear of a hoisting device; comprising:
a control element configured as handle for inputting at least one desired value by applying a manual force upon the control element;
a biasing means for prestressing the control element in a desired direction;
at least one electrical transducer, coupled to the control element, for converting the manual force acting in the desired direction into an electric signal, wherein the transducer includes a force sensor having a sensor surface which extends perpendicular to the desired direction and interacts with the control element.

2. The apparatus of claim 1, wherein the transducer includes a push rod having a curved end surface acting upon the sensor surface, wherein the control element interacts with the sensor surface via the push rod.

3. The apparatus of claim 2, wherein the push rod has a calotte-shaped pocket for receiving a ball which partially projects out of the curved end surface.

4. The apparatus of claim 1, wherein the sensor includes a bridge circuit of electric resistors which are mounted on the sensor surface.

5. The apparatus of claim 1, wherein the force sensor includes a ceramic plate having one side forming the sensor surface.

6. The apparatus of claim 2, wherein the biasing means includes a first elastic member, wherein the control element is supported by the push rod via the first elastic member.

7. The apparatus of claim 6, wherein the control element has a housing portion for accommodating the sensor surface, the push rod and the first elastic member, wherein the first elastic member is supported indirectly by an inside surface of the housing portion.

8. The apparatus of claim 7, wherein the transducer includes an actuating element which is accessible from outside and actuated by the control element in the desired direction, wherein the biasing means includes a second elastic member supported by an inside surface of the housing portion, wherein the first elastic member is supported by the inside surface via the actuating element and the second elastic member.

9. The apparatus of claim 1, wherein the control element is defined by a longitudinal axis, wherein the sensor surface extends in relation to the longitudinal axis in an orientation selected from the group consisting of parallel orientation and transverse orientation.

10. The apparatus of claim 8, wherein each of the first and second elastic members includes a helical spring, wherein the helical spring of the first elastic member and the helical spring of the second elastic member have different sizes, wherein the actuating element is configured in the form of a hat with an outwardly projecting fin and a depression having a base, with the helical spring of greater diameter extending between the inside surface of the housing portion and the fin, and with the helical spring of smaller diameter received in the depression and extending between the base of the depression and the push rod.

11. The apparatus of claim 9, wherein the control element is configured for movement in at least one of the ways selected from the group consisting of swinging about a pivot axis extending transversely to the longitudinal axis, and displacement in a direction of the longitudinal axis.

12. The apparatus of claim 9, and further comprising a metal tube extending through the control element in coaxial relationship to the longitudinal axis.

13. The apparatus of claim 12, wherein the metal tube has an upper end for attachment of a cable and a lower end for attachment of a load-receiving member.

14. The apparatus of claim 1, and further comprising three of said transducer for operation in three separate directions which extend perpendicular to one another.

15. The apparatus of claim 1, wherein the control element includes a light barrier which delivers an operating signal, when the control element is embraced by the hand of an operator.

16. The apparatus of claim 15, wherein the electric signal of the transducer is nullified in the absence of the operating signal.

17. The apparatus of claim 1, and further comprising switching elements mounted to the control element.

18. The apparatus of claim 1, and further comprising a flexible printed circuit board arranged in the control element.

19. A hand-held control apparatus for operation of a hoisting device; comprising:
a handle;
a biasing means for prestressing the handle in an actuating direction; and
a force transducer disposed in the handle for generating an electrical signal in dependence on the magnitude and direction of a force applied upon the handle in the actuating direction, said transducer having a sensor surface configured to change a resistance in response to the applied force and extending perpendicular to the actuating direction.

20. The apparatus of claim 19, wherein the transducer includes ceramic substrate having one side forming the sensor substrate, and a bridge circuit of electric resistors which are mounted on the sensor surface.

21. The apparatus of claim 19, wherein the biasing means includes two elastic members applying spring forces in opposition to one another and thereby supporting the handle in a prestressed manner.

22. The apparatus of claim 21, wherein the elastic members include helical springs.

23. The apparatus of claim 22, wherein the biasing means includes an actuating element disposed between the elastic members and operatively connected to the handle for transmitting the applied force to the sensor surface.

24. The apparatus of claim 22, wherein the helical springs have different sizes, with the helical spring of smaller size partially received in the helical spring of greater size.

25. The apparatus of claim 19, and further comprising a metal tube extending through the control element in coaxial relationship to the longitudinal axis and having an upper end for attachment of a cable and a lower end for attachment of a load-receiving member.

26. The apparatus of claim 19, and further comprising three of said transducer for operation in each of three orthogonal directions.
